(19) United States
(12) Patent Application Publication
(10) Pub. No.: US 2003/0204935 A1
(43) Pub. Date: Nov. 6, 2003

(54) Door hinge unit

(76) Inventor: Heung-Kee Kim, Sung-nam (KR)

Correspondence Address: ST. ONGE STEWARD JOHNSTON & REENS, LLC, 986 BEDFORD STREET, STAMFORD, CT, 06905-5619, US

(21) Appl. No.: 10/443,496

(22) Filed: May 22, 2003

Related U.S. Application Data
(63) Continuation of application No. PCT/KR01/01145, filed on Jul. 5, 2001.

(30) Foreign Application Priority Data
Nov. 23, 2000 (KR) 2000/70053
Jul. 4, 2001 (KR) 2001/39872

(51) Int. Cl. E05F 1/14

(52) U.S. Cl. 16/280

(57) ABSTRACT

A door hinge unit for smoothly opening and closing a door using the fluid resistance force of a fluid comprises: a cylindrical oil container containing a viscous fluid therein and having a fluid transfer groove formed along a circumferential direction at an inner wall of the container; a hinge shaft rotatably supported within the oil container with the same core axis as the oil container and whose at least one end is protruded along an axial direction of the oil container, the hinge shaft having a blade formed at an outer circumferential surface thereof and which is slidingly in contact with the inner wall of the oil container; a barrier formed crossing the inner wall of the oil container and an outer circumference of the hinge shaft and having a penetration fluid passage formed along the circumferential direction; and a restoring spring whose one end is coupled to the oil container and the other end is coupled to the hinge shaft.

### CROSS-REFERENCES TO RELATED APPLICATIONS

This application is a continuation of pending International Patent Application No. PCT/KR01/01145 filed Jul. 5, 2001, which designates the United States and claims priority of pending Korean Application Nos. 2000/70053, filed Nov. 23, 2000 and 2001/39872 filed Jul. 4, 2001.

### BACKGROUND OF THE INVENTION

1. Field of the Invention

The present invention relates to a door hinge unit for smoothly opening and closing a door using fluid resistance force of a viscous fluid, and more particularly, to a door hinge unit which is capable of controlling speed of the door according to an opening position of the door, and has a fire prevention function therein, and also has a simple structure capable of miniaturizing its size, thereby applying the door hinge unit to all kinds of doors.

2. Description of the Related Art

A door hinge functions to support a door and, and at the same time, functions as a rotational shaft of the door. Generally, in addition to the door hinge, a door closer is additionally disposed at a large-sized door such as a front door or a fire door of an apartment building so as to automatically and slowly close the open door.

The door closer is a device for smoothly performing an opening and closing operation of the door using elastic force of a spring and resistance force of a viscous fluid. One of the most known door closers is a hydraulic cylinder type door closer having a rectangular body in which a hydraulic cylinder and a return spring are mounted, wherein the rectangular body is attached to an upper portion of the door and then fixed through a pair of links to a doorframe. The hydraulic cylinder type door closer automatically closes the door using the elastic restoring force of the spring applied to a piston, and at the same time, smoothly performs the closing operation of the door using the resistance force of the viscous fluid within the hydraulic cylinder.

However, as described above, since the hydraulic cylinder type door closer is separately disposed at the door, in addition to the door hinge, and then fixedly attached through the links to the doorframe, it is limited in a mounting position. And also appearance beauty is remarkably lowered. Therefore, it is difficult that the door closer is applied to a small-sized door except the large-sized door. Further, since the hydraulic cylinder type door closer has many components and a complicated structure and also a cost of the door closer is high, there is a problem that it takes so much collateral cost when installing the door closer.

To solve the problem, there has been proposed a door hinge unit in which a blade having a check valve is formed at a hinge shaft and then received in a housing in which high viscous fluid is contained. One of the door hinge units with a door closer function is described in Korean Patent No. 202260, entitled “Automatic door closer unit”.

As shown in FIG. 1, a conventional door hinge unit has a cup-shaped housing 110 in which the high viscous fluid is contained and of which an upper portion is opened. A barrier 111 having an oil through-path 113 is integrally formed at a side portion of an inner sidewall of the housing. A flow controlling member 115 for controlling flow of oil passing through the oil through-path 113 is screwed to a screw hole 114 that communicates the oil through-path 113 and an outside of the housing.

A hinge shaft 120 is rotatably disposed in an inner portion of the housing 110. The housing 110 is formed with a blade 121 that slidably and closely contacted with the inner sidewall of the housing.

Two oil moving holes 122 are formed at the blade 121 to be apart at a desired distance. A check valve 127 is coupled to a side of the blade 121 using a screw 128 so as to open or close the oil moving holes 122 according to a rotational direction of the door. Further, at a lower portion of the blade 121, there is formed a stopper receiving groove 123 in which a spring 124 and a stopper 125 are received.

Meanwhile, a spring receiving groove is formed at a lower portion of the hinge shaft 120 so that a return spring 130 is received therein. One end of the return spring 130 is fixed to the lower portion of the housing 110 and the other end thereof is fixed to an upper sidewall of the spring receiving groove.

A cover 140 is coupled to an upper open portion of the housing 110 so as to prevent an outflow of the oil. At a center portion of the cover 140, there is formed a hinge shaft through hole through which an upper end of the hinge shaft 120 is protruded to an upper portion of the cover 140. And then a door supporting portion 150, a washer 155 and a doorframe supporting portion 160 are coupled to the upper portion of the cover 140 in order.

The door supporting portion 150 is provided with a supporting portion 151 and a connecting portion 152 perpendicularly extended from the supporting portion 151 and having a hinge shaft through-hole 153 at a center portion thereof. The door supporting portion 150 is fixed to an upper portion of the cover 140 by a screw. The doorframe supporting portion 160 has the same shape as the door supporting portion 150 and also has a coupling hole 161 having a larger diameter than the hinge shaft through-hole 153 corresponding to the hinge shaft through-hole 153 of the door supporting portion 150. At an inner circumference of the coupling hole 161, there is formed an irregular portion.

A circular wedge 170 is provided at an inner portion of the coupling hole 161 so as to compensate mismatching of the coupling hole 161 due to a position error between the doorframe and the door. At an outer circumference of the circular wedge 170, there are formed a plurality of coupling protrusions tapered upward and downward. The circular wedge 170 also has a rectangular through hole 171 in which the upper end of the hinge shaft 120 is fixedly inserted.

According to the conventional door hinge unit, described above, when opening the door, the check valve 127 is also open. The oil in the housing is moved through the oil moving holes 122 formed at the blade as well as the oil through-path 113 formed at the barrier 111. Therefore, the resistance of the oil with respect to the rotational operation of the blade is reduced. As the result, the door can be rapidly opened. The closing operation of the door is performed using the restoring force of the return spring 130. When closing the door, the check valve 127 is closed, and the oil moving holes 122 formed at the blade are blocked. Therefore, the oil in the housing is moved through only the oil through-path 113 formed at the barrier 111. As the result, the closing operation of the door is slowly performed.

Meanwhile, the stopper 125 functions to stop the door at a predetermined open position, when the door is rotated. In case the stopper 125 is arrived at a hemispheric stopping groove formed at a bottom face of the housing, a hemispheric end of the stopper 125 is inserted into the stopping groove by the elastic force of the spring 124. Therefore, the door is stopped. In this situation, when external force is applied to the door, the door is further opened or closed.

However, in the conventional door hinge unit, as described above, since the flow of the oil is decided by only an opening or closing operation of the check valve, it is impossible to variously control speed of the door according to the open position of the door. In order to provide a stopping function at the door, the hemispheric stopping groove and the stopper receiving groove have to be formed at the housing and the blade. Further, separate components such as the stopper and a spring for supporting the spring are needed. Therefore, there is a problem that a structure of the door hinge unit is complicated and also a fabricating cost is increased.

In addition, since the return spring is disposed at the inner portion of the hinge shaft, an outer diameter of the hinge shaft is increased within a desired extent. Therefore, an entire size of the door hinge unit is increased. It is difficult to reduce a size of an electronic appliance in which the door hinge unit is applied.

Further, among stairs in an apartment building, there is generally provided a fire prevention function for automatically closing each stair at a desired temperature or more, when a fire breaks out. In case of the conventional door hinge unit, there is other problem that separate fire prevention equipment should be provided.

### SUMMARY OF THE INVENTION

Therefore, it is an object of the present invention to provide a door hinge unit that is capable of facilely controlling speed of a door according to an open position of the door.

It is other object of the present invention to provide a door hinge unit that is capable of performing a sectional stopping function without a separate stopper.

It is another object of the present invention to provide a door hinge unit that has a fire prevention function therein.

It is yet another object of the present invention to provide a door hinge unit that is capable of miniaturizing its size and applying to various kinds of doors.

To achieve one of the aforementioned objects of the present invention, there is provided a door hinge unit comprising an oil container which contains a viscous fluid in an inner sidewall thereof and has a fluid moving groove formed along a circumferential direction at the inner sidewall; a hinge shaft which is rotatably supported in the oil container with the same core axis as the oil container, and of which at least one end is protruded in an axial direction of the oil container, and which has blade formed at an outer circumferential surface thereof, the blade being slidably and closely contacted with the inner sidewall; a barrier which is formed to cross between the inner sidewall of the oil container and the outer circumferential surface of the hinge shaft, and which has a oil through-path formed in the circumferential direction; and a return spring of which one end is coupled to the oil container and the other end is coupled to the hinge shaft.

Further, a heat detecting member formed of a material having a low melting point is provided at an end of the oil moving groove so as to have an inner sidewall corresponding to the inner sidewall of the oil container, thereby providing a fire prevention function without a separate fire prevention equipment.

Meanwhile, the hinge shaft is disposed so that both ends thereof are protruded to an outside of the oil container, and one end of the return spring is coupled to an end of the hinge shaft, and the other end of the return spring is coupled to an outer circumferential surface of the oil container. Therefore, it is not necessary that the return spring should be disposed at an inner portion of the hinge shaft. As the result, a diameter of the hinge shaft is miniaturized and thus the door hinge unit is miniaturized, whereby the door hinge unit can be applied to a refrigerator, a gas oven, a washing machine, a duplicating machine, a scanner, etc. as well as a door of a building or a door of a car.

### BRIEF DESCRIPTION OF THE DRAWINGS

The above objects and other advantages of the present invention will become more apparent by describing in detail preferred embodiments thereof with reference to the attached drawings in which:

FIG. 1 is an exploded perspective view of a conventional door hinge unit;

FIG. 2 is a perspective view of a door hinge unit according to an embodiment of the present invention;

FIG. 3 is an exploded perspective view of the door hinge unit according to the embodiment of the present invention;

FIG. 4 is a longitudinal cross-sectional view of the door hinge unit according to the embodiment of the present invention;

FIG. 5 is a cross-sectional view taken along a line A-A of the FIG. 4;

FIG. 6 is a lateral cross-sectional view of the door hinge unit according to the embodiment of the present invention;

FIGS. 7 and 8 are views of the door hinge unit according to other embodiment of the present invention; and

FIGS. 9 to 11 are views of the door hinge unit according to another embodiment of the present invention.

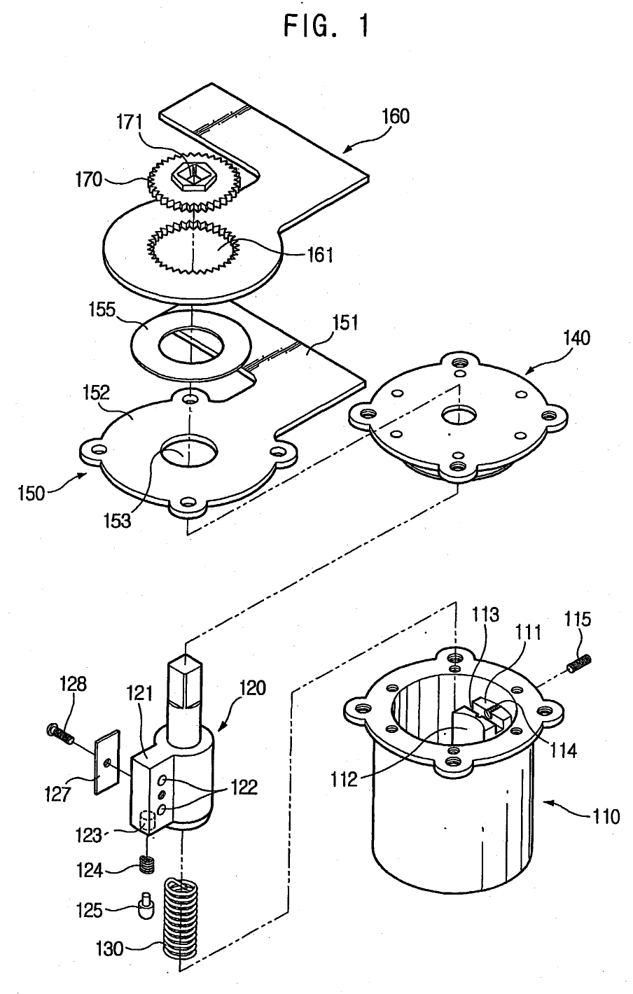

### DETAILED DESCRIPTION OF PREFERRED EMBODIMENTS

Now, preferred embodiments of the present invention will be described in detail with reference to the annexed drawings.

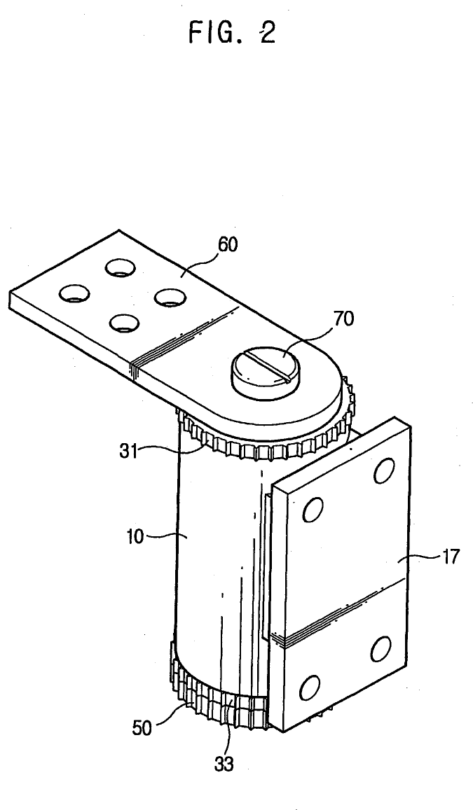

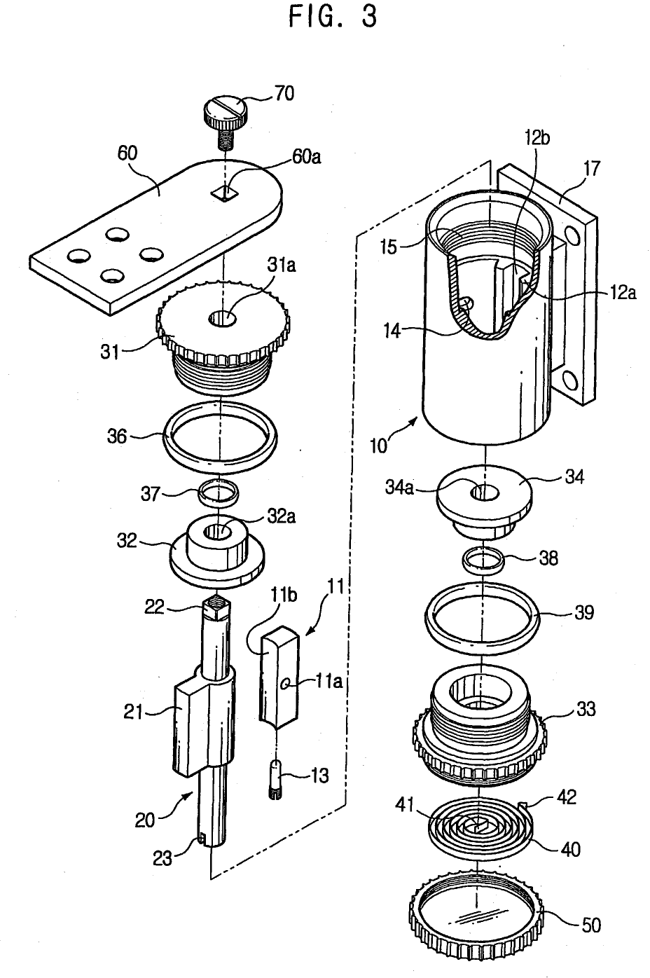

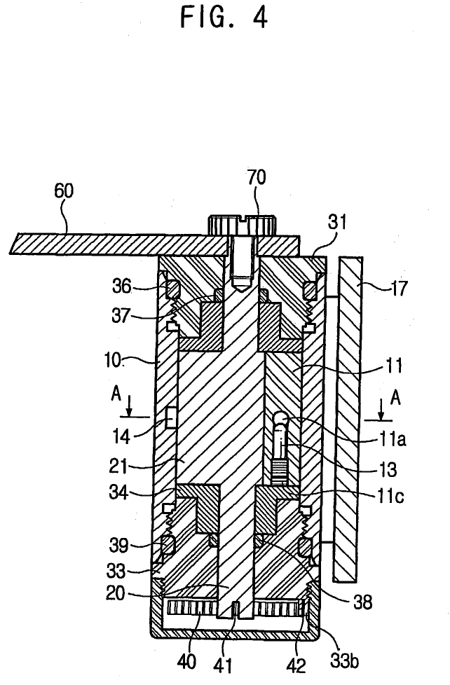

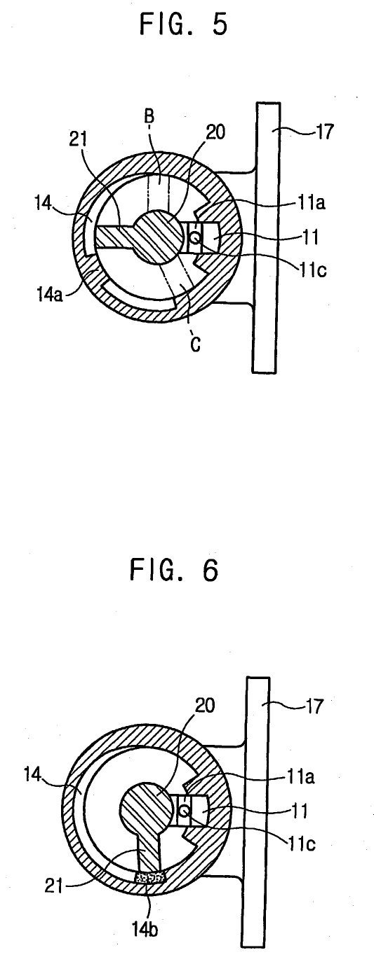

FIG. 2 is a perspective view of a door hinge unit according to an embodiment of the present invention, FIG. 3 is an exploded perspective view thereof, FIG. 4 is a longitudinal cross-section view thereof, and FIG. 5 is a cross-sectional view taken along a line A-A of the FIG. 4. Referring to each drawing, an oil container of the present invention comprises a cylindrical body 10 of which an upper portion and a lower portion are opened, an upper cover 31 and a lower cover 33 which are respectively screwed to the open upper and lower portions of the cylindrical body 10, and a washer 32, 34 which is disposed at an inner side of the upper and lower cover 31, 33.

An oil-moving groove 14 is formed in a circumferential direction on an inner sidewall of the cylindrical body 10. A barrier mounting protrusion 12a longitudinally formed on the inner sidewall of the cylindrical body 10 defines a barrier mounting groove 12b. A barrier 11 having an oil through-path 11a is inserted into the barrier mounting groove 12b. A housing bracket 17 is integrally formed on an outer sidewall of the cylindrical body 10. The housing bracket 17 may be separately fabricated and then coupled to the cylindrical body 10.

At a lower portion of the barrier 11, there is formed a flow controlling hole 11c which connects the oil through-path 11a and the cylindrical body 10. A flow-controlling member 13 for controlling flow of oil passing through the oil through-path 11a is screwed in the flow controlling hole 11c.

The washer 32, 34 that is disposed at the upper and lower cover 31, 33 and the inner side of the upper and lower cover 31, 33 is formed with a through hole 31a, 32a, 33a, 34a through which a hinge shaft 20 is passed. An oil-leak preventing member such as an o-ring 36, 37, 38, 39 is disposed between the upper and lower cover 31, 33 and the cylindrical body 10 and between the upper and lower cover 31, 33 and the washer 32, 34.

The hinge shaft 20 is rotatably disposed in an inner portion of the cylindrical body 10. A blade 21 that is slidably and closely contacted with the inner sidewall of the housing is formed at the hinge shaft 20. An upper face and a lower face of the blade 21 are also slidably and closely contacted with an inner sidewall of the washer 32, 34.

At an upper portion of the hinge shaft 20, there is formed a fixing portion 22 having a square section. The fixing portion 22 is inserted into a fixing hole 60a of a hinge shaft bracket 60 and then fixed by a hinge shaft fixing screw 70. Therefore, the hinge bracket 60 and the hinge shaft 20 are always integrally rotated without slipping each other. A circumferential surface formed at a center portion of the hinge shaft 20 is slidably and closely contacted with a supporting surface 11b formed at an end of the barrier 11.

A spring fixing groove 23 is formed at the lower portion of the hinge shaft 20. An inside end 41 of a return spring 40 is fixedly inserted into the spring fixing groove 23. An outside end 42 of the return spring 40 is fixedly inserted into a fixing groove of a spring fixing protrusion 42 formed at the lower portion of the cylindrical body 10. A spring cover 50 is screwed to the lower portion of the cylindrical body 10 so that the return spring 40 is not exposed to an outside.

A coil spring may be used as the return spring. However, it is preferable that a spiral spring is used as the return spring in order to miniaturize the door hinge unit and increase elastic restoring force.

The hinge shaft bracket 60 of the door hinge unit according to the present invention, as described above, is fixed to a door of a building or a door of a car, a refrigerator, and a gas oven, etc. Then, the housing bracket 17 is fixed to a doorframe or a main body. In this case, the door hinge unit is used as a housing fixing-hinge shaft rotating type. Meanwhile, in case the both brackets 60 and 17 are reversely fixed to the door and the doorframe or the main body, the door hinge unit is used as a hinge shaft fixing-housing rotating type. Hereinafter, the door hinge unit of the present invention will be described referring to the housing fixing-hinge shaft rotating type.

When the door, in which the hinge shaft bracket is fixed, is rotated, the blade 21 disposed at the hinge shaft 20 is also rotated together with the door, while being subjected to fluid resistance force of the oil. The viscous oil is moved through the oil through-path 11a formed at the barrier 11 and the oil moving groove 14 formed at the inner sidewall of the cylindrical body 10 to a front and rear portion of the blade 21. Therefore, an opening and closing operation of the door is smoothly and slowly performed.

Meanwhile, as shown in FIG. 5, the oil moving groove 14 has a different width and depth along a circumferential direction so as to control the flow of the oil passing through the oil moving groove 14 and thus to change the resistance force of the oil exerted on the blade 21, thereby controlling an opening or closing speed of the door. According to the embodiment, while the door is moved from an opening position to a close position (B) due to the elastic restoring force of the spring, the closing speed of the door is gradually reduced, so that the door is smoothly closed. When the blade 21 is located at a stop portion 14a formed to have an internal circumferential surface corresponding to an internal circumferential surface of the cylindrical body at a middle portion of the oil moving groove 14, since the flowing path of the oil is limited in the oil through-path 11a formed at the barrier, the fluid resistance force of the oil exerted on the blade 21 is increased. Therefore, the closing operation of the door is not performed only with the restoring force of the return spring due to a weight of the door and frictional force applied to an outer sidewall of the blade, etc. The door is partially open. Also, in a complete open position (C), the door is kept to be open due to the same principle.

In this situation, if external force is applied to the door, it is possible that the door is further opened or closed.

FIG. 6 shows an embodiment in which a heat detecting member 14b formed of a material having a low melting point is provided at the complete open position of the door, i.e., an end of the oil moving groove 14 so as to have an inner sidewall corresponding to the inner sidewall of the oil container, and thus to form the door with a fire prevention function. If the blade 21 is located on the heat detecting member 14b at ordinary times, since the oil moving groove 14 is closed, the door is kept to be open. However, when a fire breaks out, the heat detecting member 14b is melted by high temperature and the oil moving groove 14 is thus open. Therefore, the door is closed due to the elastic restoring force, thereby preventing the fire from spreading to other regions.

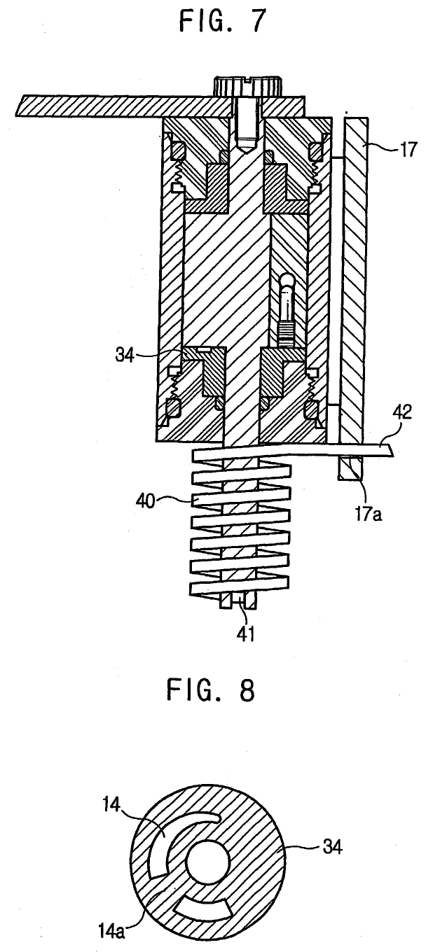

FIGS. 7 and 8 are views showing other embodiment of the present invention. A coil spring is used as the return spring 40. A lower end 41 of the coil spring is fixed to the spring fixing groove 23 of the hinge shaft, and an upper end thereof is fixed inserted into a spring inserting hole 17a of the housing bracket 17. Further, the oil moving groove 14 is formed at the upper surface of the lower washer 34.

In this embodiment, although the oil moving groove 14 is formed at the inner wall of an upper or lower portion of the oil container, an operation thereof is performed in the same way in the previous embodiment. Therefore, a description of the operation will be omitted.

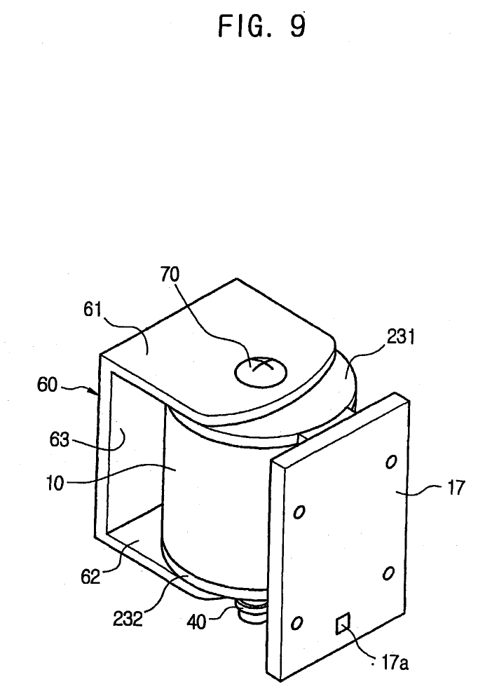

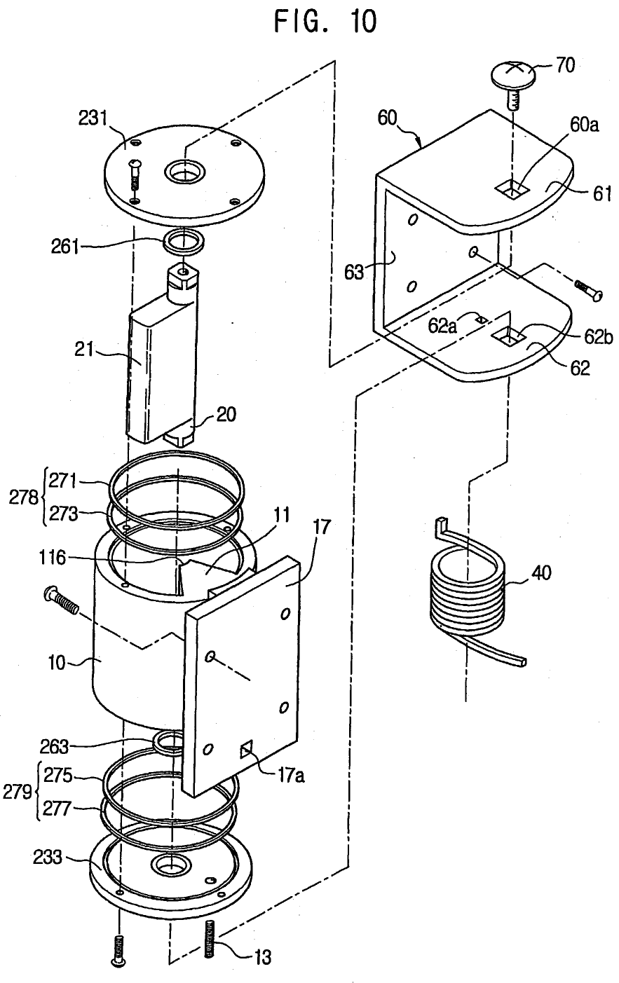

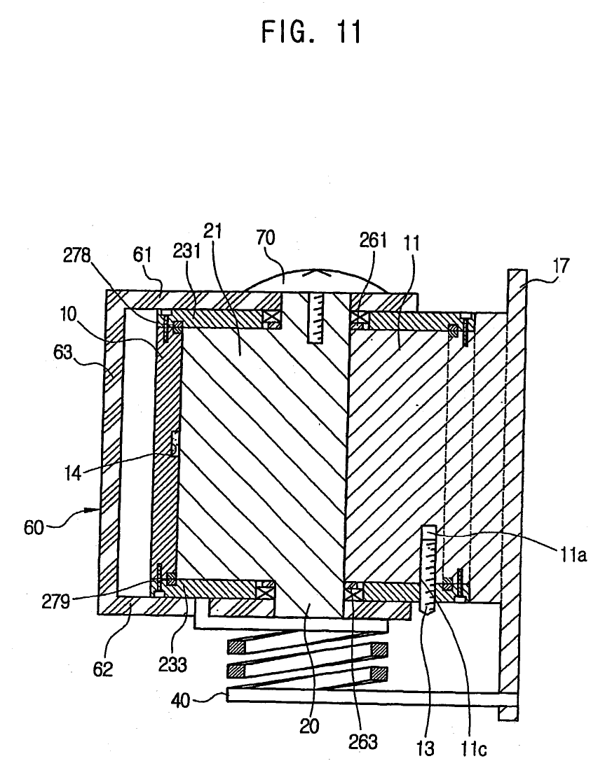

FIGS. 9 to 11 are a perspective view, an exploded perspective view and a longitudinal cross-sectional view of another embodiment of the present invention. In this embodiment, components having the same functions as those in the previous embodiment are designated by the same reference numerals. The description thereof will be also omitted.

In the door hinge unit of the embodiment, upper and lower hosing covers 231 and 233 are respectively coupled to the open portions of the cylindrical body 10 using a separate screw, so that the housing covers 231 and 233 themselves form the inner wall of the upper and lower portions of the oil container. The barrier 11 having the hinge shaft supporting surface 116 is integrally formed at the cylindrical body 10. It is also possible that the lower portion of the cylindrical body is formed to be a closed type in the same way as that in the conventional door hinge unit.

In addition, the hinge shaft bracket 60 is formed with a plate 63, and rugs 61 and 62 integrally bended at an upper and lower end of the plate 63. Each of the rugs 61 and 62 has a rectangular hinge shaft fixing hole 60a and 62b in which the upper and lower portion of the hinge shaft 20 is inserted. The lower rug 62 is formed with a spring fixing hole 62a. The upper end of the return spring 40 is fixedly inserted into the spring inserting hole 62a and the lower end of the return spring 40 is fixedly inserted into the spring inserting groove 17a formed at the housing bracket 17.

Reference numerals 261 and 263 designate O-rings, and reference numerals 278 and 279 are the oil-leak preventing member comprised of the O-rings 271 and 277and bushes 273 and 277.

According to the door hinge unit of the present invention, as described above, the oil moving groove has a different width and depth along the circumferential direction thereof so as to facilely control the speed of the door according to the open position of the door. Further, a sectional stopping operation of the door can be performed without a separate stopper.

### Industrial Applicability

As described above, the power saving outlet according to the present invention is further provided with the up/down moving table and the push button portion so as to safely cut off power even though the plug is not pulled out and further prevent a risk of electrical shock to children due to carelessness when the plug is released from the outlet.

While the present invention has been described in detail, it should be understood that various changes, substitutions and alterations can be made hereto without departing from the spirit and scope of the invention as defined by the appended claims.

What is claimed is:

1. A door hinge unit, comprising:
an oil container which contains a viscous fluid in an inner sidewall thereof and has a fluid moving groove formed along a circumferential direction at the inner sidewall;
a hinge shaft which is rotatably supported in the oil container with the same core axis as the oil container, and of which at least one end is protruded in an axial direction of the oil container, and which has blade formed at an outer circumferential surface thereof, the blade being slidably and closely contacted with the inner sidewall;
a barrier which is formed to cross between the inner sidewall of the oil container and the outer circumferential surface of the hinge shaft, and which has a oil through-path formed in the circumferential direction; and
a return spring of which one end is coupled to the oil container and the other end is coupled to the hinge shaft.

2. The unit of claim 1, wherein the oil container is comprised of a cylindrical body on which upper and lower portions are opened to form the cylindrical inner sidewall thereof, upper and lower covers which are respectively coupled to the upper and lower portions of the cylindrical body, and a washer which is disposed at an inner portion of each of the upper and lower covers to form an inner sidewall of the upper and lower portions of the oil container.

3. The unit of claim 1, wherein the barrier is integrally formed at the inner sidewall of the oil container.

4. The unit of claim 1, wherein the hinge shaft is disposed so that both ends thereof are protruded to an outside of the oil container, and one end of the return spring is coupled to an end of the hinge shaft, and the other end of the return spring is coupled to an outer circumferential surface of the oil container.

5. The unit of claim 4, wherein the return spring is a spiral spring.

6. The unit of claim 4, wherein a spring cover is disposed at the outer circumferential surface of the oil container, and the return spring is received at an inner portion of the spring cover.

7. The unit of claim 1, wherein the oil moving groove has a different width in the circumferential direction.

8. The unit of claim 1, wherein the oil moving groove has a different depth in the circumferential direction.

9. The unit of claim 1, wherein a stopping surface is formed at a middle portion of the oil moving groove to have an inner sidewall corresponding to the inner sidewall of the oil container.

10. The unit of claim 1, wherein a heat detecting member formed of a material having a low melting point is provided at an end of the oil moving groove so as to have an inner sidewall corresponding to the inner sidewall of the oil container.

11. The unit of claim 1, wherein the oil moving groove is formed on the inner sidewall of the oil container.

12. The unit of claim 1, wherein the oil moving groove is formed on at least one of the inner walls of the upper and lower portions of the oil container.
